(19) United States
(12) Patent Application Publication
(10) Pub. No.: US 2024/0214124 A1
(43) Pub. Date: Jun. 27, 2024

(54) ABNORMAL FRAME DETERMINATION DEVICE, ABNORMAL FRAME DETERMINATION METHOD, AND NON-TRANSITORY COMPUTER READABLE MEDIUM

(71) Applicant: DENSO CORPORATION, Kariya-city (JP)

(72) Inventors: Remma TAKEUCHI, Kariya-city (JP); Tatsuro KAWAKAMI, Kariya-city (JP); Michitaka FUKUSHIMA, Kariya-city (JP)

(21) Appl. No.: 18/542,855

(22) Filed: Dec. 18, 2023

(30) Foreign Application Priority Data
Dec. 27, 2022 (JP) 2022-209408

(51) Int. Cl. H04L 1/1803; H04L 1/00

(52) U.S. Cl. CPC H04L 1/1803; H04L 1/0083

(57) ABSTRACT

An abnormal frame determination device receives data frames which are transmitted by an electronic control unit at a predetermined period. A receipt interval between a first data frame and a second data frame is calculated. The second data frame is received immediately before receipt of the first data frame. A predetermined value is added to a determination value stored in a storage when the receipt interval is shorter than a threshold. It is determined that the second data frame is an abnormal frame when the determination value reaches a limit value and the receipt interval is longer than a proximity receipt interval that is a criterion for determining whether the first data frame and the second data frame are received in proximity to each other.

### CROSS REFERENCE TO RELATED APPLICATION

This application is based on and incorporates herein by reference Japanese Patent Application No. 2022-209408 filed on Dec. 27, 2022.

### TECHNICAL FIELD

The present disclosure relates to a technique for determining an abnormal data frame from among data frames transmitted from an electronic control unit.

### BACKGROUND

Conventionally, a variety of types of electronic control units are mounted on an automobile, and an in-vehicle system includes these electronic control units connected to each other via a communication network.

According to an aspect of the present disclosure, an abnormal frame determination device receives data frames which are transmitted by an electronic control unit at a predetermined period. A receipt interval between a first data frame and a second data frame is calculated. The second data frame is received immediately before receipt of the first data frame. A predetermined value is added to a determination value stored in a storage when the receipt interval is shorter than a threshold. It is determined that the second data frame is an abnormal frame when the determination value reaches a limit value and the receipt interval is longer than a proximity receipt interval that is a criterion for determining whether the first data frame and the second data frame are received in proximity to each other.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a diagram illustrating an in-vehicle system including an abnormal frame determination device according to a first embodiment or a second embodiment.

FIG. 2 is a diagram illustrating a configuration example of the abnormal frame determination device according to the first embodiment or the second embodiment.

FIG. 3 is a diagram illustrating time stamps added by a time stamper according to the first embodiment or the second embodiment.

FIG. 4 is a diagram illustrating a receipt interval of data frames and a determination value according to the first embodiment.

FIG. 5 is a diagram illustrating a receipt interval of data frames and a determination value according to the first embodiment.

FIG. 6 is a diagram illustrating a receipt interval of data frames and a determination value according to the first embodiment.

FIG. 7 is a diagram illustrating a receipt interval of data frames and a determination value according to the first embodiment.

FIG. 8 is a diagram illustrating an operation of an abnormal frame determination device according to the first embodiment.

FIG. 9 is a diagram illustrating an operation of the abnormal frame determination device according to the first embodiment.

FIG. 10 is a diagram illustrating an operation of an abnormal frame determination device according to the second embodiment.

FIG. 11 is a diagram illustrating an operation of the abnormal frame determination device according to the second embodiment.

### DETAILED DESCRIPTION

To begin with, examples of relevant techniques will be described. A variety of types of electronic control units are mounted on an automobile, and an in-vehicle system includes these electronic control units connected to each other via a communication network. Such in-vehicle system is known to use a Network-based Intrusion Detection System (NIDS) to detect whether there is a suspicious access or data from the outside.

For example, a communication system according to a first comparative example is capable of determining whether messages communicated in the communication system are normal or abnormal with a simple configuration. In this communication system, multiple ECUs are connected to a communication bus to enable communication of messages. A predetermined communication interval is set for each ECU, and an ECU transmits messages based on the predetermined communication interval. Then, when a communication interval of received messages is shorter than the predetermined communication interval, it is determined that the messages are not normal.

A relay connection unit according to a second comparative example relays messages transmitted and received between electronic control units. The relay connection unit counts the number of receipts of a message received within a predetermined set time, and determines that the message is not normal when the number of receipts exceeds a set number of receipts.

The communication interval of the message in the first comparative example can be calculated by using a time indicated by a time stamp added to the received message. However, depending on the time resolution of the time stamp, a time difference between the actual time and the time indicated by the added time stamp may increase. The time difference may cause error in determination whether the message is normal or abnormal. According to the method of the second comparative example, the possibility of erroneous determination due to low time resolution of the time stamp is reduced. However, since it is necessary to temporarily store a receipt time of each of the messages received within the set time, a memory consumption may increase. Furthermore, in the second comparative example, it is not possible to specify which message is abnormal among the messages that have been counted in the number of receipts.

In contrary, according to the present disclosure, it can be determined whether received data frames include an abnormal data frame and it can be determined which received data frame is the abnormal data frame.

An abnormal frame determination device is configured to be connected to an electronic control unit configured to transmit data frames at a predetermined period. The abnormal frame determination device includes a receiver, an interval calculator, a storage, a value updater and a frame determiner. The receiver is configured to receive a first data frame estimated to have been transmitted from the electronic control unit. The interval calculator is configured to calculate a receipt interval between the first data frame and a second data frame. The second data frame is a data frame received by the receiver immediately before the receiver receives the first data frame. The storage is configured to store a determination value for detecting an abnormal frame. The value updater is configured to add a predetermined value to the determination value when the receipt interval is shorter than a threshold. The frame determiner is configured to determine that the second data frame is the abnormal frame when the determination value reaches a limit value and the receipt interval is longer than a proximity receipt interval that is a criterion for determining whether the first data frame and the second data frame are received in proximity to each other.

According to the above-described configuration, the abnormal frame determination device according to the present disclosure can determine with high accuracy that an abnormal data frame is included in received data frames, and can also determine which data frame among the received data frames is the abnormal data frame.

Embodiments of the present disclosure will be described below with reference to the drawings.

Any effects described in embodiments may be effects obtained by a configuration of an embodiment as an example of the present disclosure, and may not be necessarily effects of the present disclosure.

In the present disclosure, the configuration disclosed in each embodiment is not limited to each embodiment alone, but may be combined across the embodiments. For example, the configuration disclosed in one embodiment may be combined with other embodiments. The disclosed configurations in respective multiple embodiments may be partially combined with one another.

A difficulty described above is not a publicly known matter but is originally found by the inventor in the present disclosure, and is a fact that confirms non-obviousness of the present application together with a configuration and a method described in the present disclosure.

### Configurations Common to the Embodiments

### (1) In-Vehicle System 1

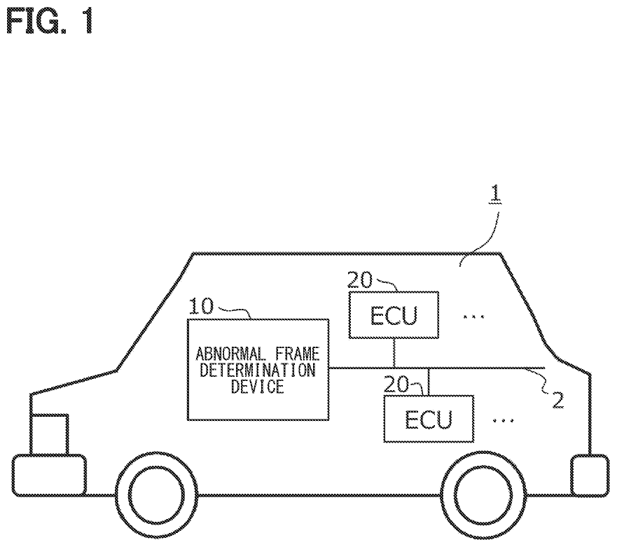

FIG. 1 illustrates an in-vehicle system 1 including an abnormal frame determination device 10, multiple electronic control units 20 (hereinafter, referred to as ECU), and a communication network 2 that connects these device and units to each other. In each of the embodiments described below, an electronic control unit functioning as a gateway has also a function of the abnormal frame determination device 10. This electronic control unit receives data frames transmitted from the ECUs 20, and executes a series of process of abnormal frame determination described later. However, the abnormal frame determination device 10 of the embodiments is not limited to the electronic control unit functioning as the gateway. For example, the abnormal frame determination device 10 of the embodiments may be provided in the in-vehicle system 1 as an electronic control unit dedicated to the abnormal frame determination, or each ECU 20 constituting the in-vehicle system 1 may have the function of the abnormal frame determination device 10. The abnormal frame determination device 10 may include a processor configured to execute instructions of a program stored in a memory.

The communication network 2 may use communication standards such as, a controller area network (CAN), a local interconnect network (LIN), Ethernet (registered trademark), Wi-Fi (registered trademark), and any other suitable communications. In the examples shown below, the communication network 2 uses CAN.

The ECUs 20 are each an “electronic control unit” that transmits data frames to the abnormal frame determination device 10 periodically, i.e., at a transmission predetermined period. Each of data frames transmitted by the ECUs 20 at the predetermined period contains various data as detection results of sensors mounted on the vehicle and/or a control value for vehicle control.

Here, the “electronic control unit” may be not only a physically independent electronic control unit but also a virtual electronic control unit implemented by using a virtualization technology.

In each embodiment, the abnormal frame determination device 10 and the ECUs 20 constitutes the in-vehicle system 1 mounted on a vehicle, for example. However, the abnormal frame determination device 10 is not limited to a device mounted on the vehicle, and can be applied to any system.

### (2) Configuration of Abnormal Frame Determination Device 10

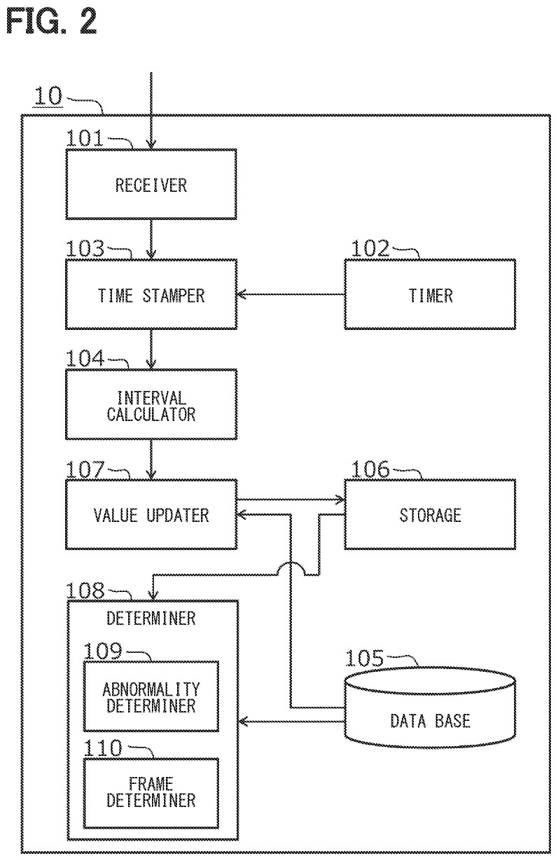

The configuration of the abnormal frame determination device 10 will be described with reference to FIG. 2. The abnormal frame determination device 10 includes a receiver 101, a timer 102, a time stamper 103, an interval calculator 104, a database 105, a storage 106, a value updater 107, and a determiner 108. The determiner 108 implements an abnormality determiner 109 and a frame determiner 110.

The receiver 101 receives a data frame (corresponding to a “first data frame”) estimated to have been transmitted from an ECU 20 via the CAN. In principle, the data frame received by the receiver 101 is a data frame transmitted from the ECU 20. However, when an external attacker inserts a faked data frame via unauthorized access such that a transmission source of the faked data frame seems to be the ECU 20, the receiver 101 erroneously recognizes the received faked data frame as a data frame transmitted from the ECU 20. That is, the receiver 101 receives not only the data frame actually transmitted from the ECU 20 but also the data frame erroneously recognized as being transmitted from the ECU 20.

The timer 102 is a clock of the abnormal frame determination device 10. The timer 102 may have any configuration. For example, the timer may include a free-run counter that counts an internal clock at the same time as activation of the abnormal frame determination device 10, a frequency division counter that divides and counts an internal clock frequency, or a timer that refers to an absolute time acquired by GPS.

The time stamper 103 adds a time stamp to the data frame based on the time of the timer 102. The time stamp indicates a time when the receiver 101 receives the data frame. The time stamper 103 samples, at a preset sampling period, the data frame received by the receiver 101 and adds the time stamp. Therefore, strictly speaking, a time-stamping time that is a time of adding the time stamp to the data frame and an actual receipt time that is a time of the receiver 101 actually receiving the data frame may be different from each other.

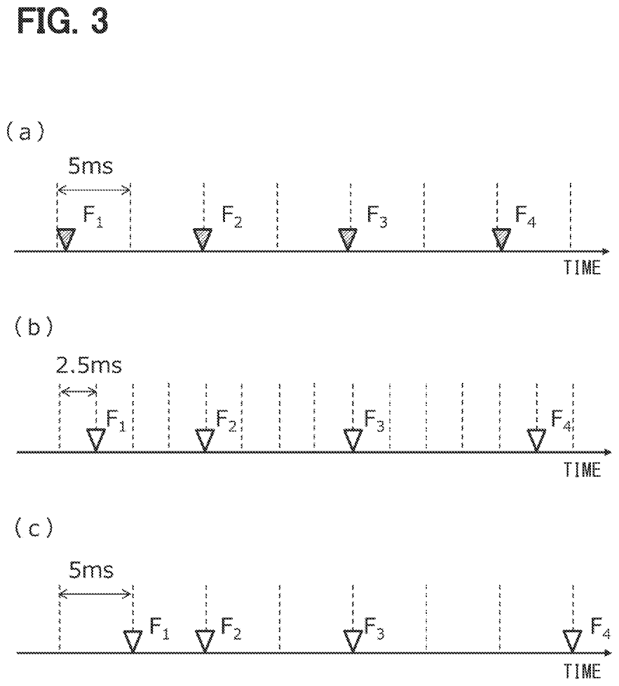

The time stamp added by the time stamper 103 and a receipt interval of the data frame will be described with reference to FIG. 3. FIG. 3(a) illustrates data frames F1, F2, F3 and F4 positioned at actual receipt times of the receiver 101 actually receiving the data frames. In this example, the receiver 101 receives the data frames at a receipt interval of about 10 ms. FIGS. 3(b) and (c) illustrate data frames F1, F2, F3 and F4 positioned at time-stamping times of the time stamper adding time stamps in cases where each data frame of FIG. 3(a) is sampled at a sampling period of 2.5 ms and 5 ms, respectively. As is apparent from the comparison between FIG. 3(a) and FIGS. 3(b) and (c), there is a time difference between an actual receipt time of a data frame and a time-stamping time of the data frame. This difference becomes more significant as the sampling period becomes longer.

For example, a receipt interval between the data frames F1 and F2 shown in FIG. 3(a) is actually about 10 ms while a receipt interval based on times indicated by time stamps added to the data frames F1 and F2 shown in FIG. 3(b) is 7.5 ms. Further, a receipt interval based on times indicated by time stamps added to the data frames F1 and F2 shown in FIG. 3(c) is 5 ms. As described above, the receipt intervals between the data frames F1 and F2 shown in FIGS. 3(b) and (c) are shorter than a transmission interval at which the ECU 20 actually transmits the data frames. Therefore, the data frame F1 or the data frame F2 may be determined to be an abnormal data frame (hereinafter, referred to as an abnormal frame) when abnormality of a data frame is determined based only on a receipt interval between two data frames.

On the other hand, a receipt interval between the data frames F3 and F4 shown in FIG. 3(a) is actually about 10 ms while a receipt interval based on the time-stamping times shown in FIG. 3(b) is 12.5 ms. Further, a receipt interval based on the time-stamping times shown in FIG. 3(c) is 15 ms. As described above, the receipt intervals between the data frames F3 and F4 shown in FIGS. 3(b) and (c) are longer than the transmission interval at which the ECU 20 actually transmits the data frames.

The interval calculator 104 calculates a receipt interval P between a currently received data frame (corresponding to “first data frame”) received by the receiver 101 and an immediately preceding data frame (corresponding to “second data frame”) received by the receiver 101 immediately before receipt of the currently received data frame based on time-stamping times indicated by time stamps added to these data frames.

As described above, the ECU 20 transmits the data frame at the predetermined period. Therefore, the receipt interval of the data frames received by the receiver 101 of the abnormal frame determination device 10 is basically equal to the transmission interval of the ECU 20. However, when the receiver 101 receives an abnormal frame inserted via unauthorized access, the receipt interval of the data frames becomes shorter than the transmission interval. Further, as illustrated in FIG. 3, the receipt interval of the data frames may become shorter or longer than the transmission interval due to the difference between the time indicated by the time stamp and the actual receipt time or due to a delay in transmission of the data frame by congestion of the communication network 2.

The database 105 stores a threshold P_{T} of the receipt interval of data frames received by the receiver 101. The database 105 further stores a criterion for the abnormality determiner 109 determining whether an abnormal frame is present in the data frames received by the receiver 101. In other words, the database 105 stores a limit value C_{L} of a determination value C used as a criterion for detecting the abnormal frame. The database 105 may be a nonvolatile memory such as a ROM, a flash memory, or a hard disk. When the receiver 101 receives multiple types of data frames having different identification information (e.g., ECU-ID or CAN-ID) or different data types, the database 105 may store the threshold P_{T} and the limit value C_{L} of the receipt interval for each type of data frame. Then, the determiner 108, which will be described later, determines the presence or absence of an abnormal frame and which data frame is an abnormal frame among data frames having the same identification information or the same data type.

The threshold P_{T} and the limit value C_{L} in the present embodiment are assumed to be fixed values. In this case, the threshold P_{T} and the limit value C_{L} are stored in the database 105 in, for example, a manufacturing factory of the abnormal frame determination device 10 or a dealer that sells a vehicle on which the in-vehicle system 1 is mounted. However, the threshold P_{T} and the limit value C_{L} may be variable values that dynamically change according to various parameters. For example, when the communication network 2 is congested, there is a high possibility that the data frame is received with a delay. Therefore, when the load of the communication network 2 is high, the threshold P_{T} or the limit value C_{L} of the receipt interval P may be automatically set to be larger than those set in a normal state in which the load of the communication network 2 is not high. The threshold P_{T} and the limit value C_{L} stored in the database 105 will be described later.

The storage 106 stores the determination value C used for detecting an abnormal frame. The determination value stored in the storage 106 is appropriately updated by the value updater 107 described later. The storage 106 may be a volatile memory such as a RAM, and the data of the determination value is erased when the power of the abnormal frame determination device 10 is turned off. When the power is turned on again, the determination value is reset to a preset initial value (Cₗₙᵢ). However, the storage 106 may be a hard disk (HDD), a flash memory, or the like.

The storage 106 may further store a value that is the determination value stored before being updated by the value updater 107. For example, in addition to the determination value C, the storage 106 may store at least two determination values before being updated by the value updater 107 to the determination value C. More specifically, the storage 106 may store a determination value C1 before the determination value C1 being updated to the determination value C, and a determination value C2 before the determination value C2 being updated to the determination value C1. These determination values C, C1, C2 change each time the value updater 107 performs updating. When the determination values are newly updated, the value stored as the determination value C becomes the determination value C1, and the value stored as the determination value C1 becomes the determination value C2.

The value updater 107 compares the receipt interval P calculated by the interval calculator 104 with the threshold P_{T} stored in the database 105. Then, the determination value C stored in the storage 106 is updated according to the comparison result. More specifically, when the receipt interval P is shorter “than” the threshold P_{T}, the value updater 107 updates the determination value C by “addition” of a “predetermined” value to the determination value C. Further, when the receipt interval P is longer “than” the threshold P_{T}, the value updater 107 updates the determination value C by “subtraction” of the “predetermined” value from the determination value C. The determination value C stored in the storage 106 is overwritten with the updated determination value C.

The term “than” described above includes both cases where a first object contains the same value as a second object in comparison and where the first object does not contain the same value as the second object in comparison.

The term “predetermined” described above includes “always constant” and “uniquely determined according to conditions”.

The term “addition” described above includes a calculation of adding a negative value to the determination value C as well as a calculation of adding a positive value to the determination value C. Further, “addition” is sufficient as long as an operation of adding a predetermined value is performed. For example, the determination value C before and after the operation may not change when the value reaches a maximum value Cₘₐₓ or a minimum value Cₘᵢₙ of the determination value C.

The term “subtraction” described above includes a calculation of subtracting a negative value from the determination value C as well as a calculation of subtracting a positive value from the determination value C. Further, “subtraction” is sufficient as long as an operation of subtracting a predetermined value is performed. For example, the determination value C before and after the operation may not necessarily change when the value reaches the maximum value Cₘₐₓ or the minimum value Cₘᵢₙ of the determination value C.

The predetermined value is, for example, a value calculated based on a “difference” between the receipt interval P of the data frames calculated by the interval calculator 104 and the threshold P_{T} of the receipt interval. For example, the “difference” itself between the receipt interval P and the threshold P_{T} may be set as the predetermined value. More specifically, when the receipt interval P is shorter than the threshold P_{T}, the value updater 107 updates the determination value C by addition of the predetermined value, i.e., addition of a difference (i.e., P_{T}−P) between the receipt interval P of the data frames and the threshold P_{T}, to the determination value C stored in the storage 106. When the receipt interval P is longer than the threshold P_{T}, the value updater 107 updates the determination value C by subtraction of the predetermined value, i.e., subtraction of a difference (i.e., P−P_{T}) between the receipt interval P of the data frames and the threshold P_{T} from the determination value C. In this case, it can be said that the determination value C is a total value of differences between the receipt interval P and the threshold P_{T}. In the following embodiment, a case where the predetermined value is a difference between the receipt interval P and the threshold P_{T} will be described as an example.

The term “difference” described above only has to include a subtraction and includes not only simple difference (y−x) but also square difference (y2−x2), square root of a difference ((y−x)½), and weighted difference (by −ax: a and b are constants), for example.

The determination value C may not be a total value of the difference itself between the receipt interval P and the threshold P_{T}, and may be a total value of numerical values associated in advance with the magnitude of the difference. For example, the difference between the receipt interval P of the data frames and the threshold P_{T} is classified into multiple ranges in advance, and the database 105 stores the ranges of the difference between the receipt interval P and the threshold P_{T} and numerical values associated with the respective ranges in a table. When the difference between the receipt interval P and the threshold P_{T} is within a specific difference range, the determination value C is updated by addition or subtraction of a numerical value associated with the range as the predetermined value.

In another example, the determination value C is a value indicating the number of times the receipt interval P of the data frames is shorter than the threshold P_{T}. For example, the value updater 107 adds “1” as the predetermined value to the determination value C stored in the storage 106 when the receipt interval P is shorter than the threshold P_{T}. The value updater 107 subtracts “1” as the predetermined value from the determination value C when the receipt interval P is longer than the threshold P_{T}. The predetermined value to be added to the determination value C is not necessarily “1”, and may be set to any other numerical value.

The minimum value Cₘᵢₙ and the maximum value Cₘₐₓ may be set in advance for the determination value C. In this case, when the receipt interval P is longer than the threshold P_{T} and the determination value C is equal to the minimum value Cₘᵢₙ, the value updater 107 may replace the determination value C with the minimum value Cₘᵢₙ after the subtraction or may not execute the subtraction. Similarly, when the receipt interval P is shorter than the threshold P_{T} and the determination value C is equal to the maximum value Cₘₐₓ, the value updater 107 may replace the determination value C with the maximum value Cₘₐₓ after the addition or may not perform the addition. However, as will be described later, the frame determiner 110 determines whether the determination value C reaches the limit value C_{L} for the first time based on the order of the addition and the subtraction. In this case, even when the subtraction or the addition is not actually performed, it is determined that the subtraction has been performed by the value updater 107 when the receipt interval P is longer than the threshold P_{T}, and that the addition is performed by the value updater 107 when the receipt interval P is shorter than the threshold P_{T}. As an example, the maximum value Cₘₐₓ of the determination value C may be equal to the limit value C_{L} of the determination value C. As an example, the minimum value Cₘᵢₙ of the determination value C may be set to zero. In this case, the determination value C is always a positive value. The minimum value Cₘᵢₙ of the determination value C may be equal to an initial value Cₘᵢₙ of the determination value C.

The abnormality determiner 109 of the determiner 108 compares the determination value C updated by the value updater 107 with the limit value C_{L} stored in the database 105. When it is determined that the determination value C has reached the limit value C_{L}, that is, when it is determined that the determination value C is equal to or greater than the limit value C_{L} (C≥C_{L}), the abnormality determiner 109 determines that an abnormal frame is present in the data frames received by the receiver 101. When the maximum value Cₘₐₓ of the determination value C is equal to the limit value C_{L}, the determination value C does not become a value larger than the limit value C_{L}. Therefore, when the determination value C is equal to the limit value C_{L} (C=C_{L}), the abnormality determiner 109 determines that an abnormal frame is present.

When the abnormality determiner 109 determines that an abnormal frame is present, the frame determiner 110 of the determiner 108 determines which of the data frames received by the receiver 101 is the abnormal frame. A determination method by the frame determiner 110 will be described later in each embodiment.

When the frame determiner 110 determines that a specific data frame is the abnormal frame, the frame determiner 110 may discard the abnormal data frame. Alternatively, information indicating the abnormal frame may be added to the data frames.

### (3) Setting of Various Parameters

Next, setting of parameters used in each embodiment will be described.

### (a) Threshold (P_{T})

The threshold P_{T} of the receipt interval P is set to a value equal to or less than a predetermined period T at which each ECU 20 transmits a data frame (i.e., the threshold P_{T}≤ the predetermined period T). This is because, when the receipt interval P between two data frames is equal to or less than the predetermined period T, there is a possibility that one of the data frames is an abnormal frame that has been inserted via unauthorized access. However, as described above, the receipt time of the data frame transmitted from the ECU 20 may be changed due to a difference between the time-stamping time and the actual receipt time or due to congestion of the communication network 2. Therefore, the receipt interval P between two normal data frames may possibly become less than or equal to the predetermined period T. Therefore, more preferably, the threshold P_{T} of the receipt interval P is set to a value equal to a minimum value P_{Min} of a receipt interval between two normal data frames transmitted from the ECU 20 (i.e., the threshold P_{T}=the minimum value P_{Min} of the receipt interval). When the threshold P_{T} is set to a value equal to the minimum value P_{Min} of the receipt interval, and the receiver 101 does not receive an abnormal frame and receives only a normal data frame transmitted from the ECU 20, the receipt interval P of two data frames becomes longer than the threshold P_{T}.

The minimum value P_{Min} of the receipt interval may be, for example, a minimum value of a receipt interval measured when data frames are transmitted at the predetermined period T by the ECU 20 actually mounted on the in-vehicle system 1. In another example, the minimum value P_{Min} may be a value of 90% or 80% of the predetermined period T at which the ECU 20 transmits the data frames.

### (b) Limit Value (C_{L})

The limit value C_{L} of the determination value C may preferably be set to a value such that the determination value C reaches the limit value C_{L} at the time of receiving a subsequent one of two normal data frames transmitted from the ECU 20 while an unauthorized data frame is inserted between the two normal data frames. For example, the limit value C_{L} is set to a value equal to or less than a value obtained by subtracting a predetermined period T from twice the threshold P_{T} (i.e., the limit value C_{L}≤2× the threshold P_{T}−the predetermined period T).

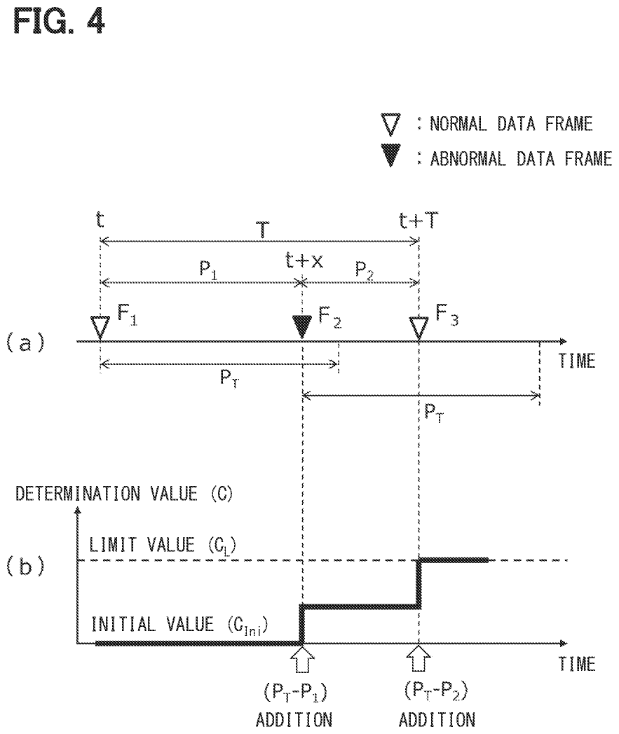

FIG. 4 is a diagram illustrating an example of a case where an abnormal frame F2 is inserted between two normal data frames F1 and F3. FIG. 4(a) illustrates time-stamping times at which a time stamp is added to the data frames and the receipt intervals based on the time-stamping times. The times at which the data frames F1 to F3 are received are t, t+x, and t+T, respectively. That is, in this example, the receipt interval of the normal data frames F1 and F3 is equal to the predetermined period T of transmission by the ECU 20. FIG. 4(b) illustrates a determination value C that changes according to the receipt intervals of the data frames F1 to F3. The determination value C at the time of receiving the data frame F1 is the initial value Cₘᵢₙ of the determination value, and is 0 in this example.

As illustrated in FIG. 4, since the receipt interval P1 between the data frames F1 and F2 is shorter than the threshold P_{T}, the value updater 107 adds the difference (P_{T}−P1) between the receipt interval P1 of the data frames F1 and F2 and the threshold P_{T} to the determination value C. Here, since the receipt times of the data frames F1 and F2 are t and t+x, respectively, the receipt interval P1 is (t+x)−x, that is, x. Therefore, the difference (P_{T}−x) is added to the determination value C. Further, since the receipt interval P2 between the data frames F2 and F3 is shorter than the threshold P_{T}, the value updater 107 adds the difference (P_{T}−P2) between the receipt interval P2 of the data frames F2 and F3 and the threshold P_{T} to the determination value C. Here, since the receipt times of the data frames F2 and F3 are t+x and t+T, respectively, the receipt interval P2 is (t+T)−(t+x), that is, T−x. Therefore, the difference (P_{T}−(T−x)) is added to the determination value C.

In the example of FIG. 4, the determination value C reaches the limit value C_{L} when receiving the data frame F3. Therefore, the following expressions are established.

$$CL \leq ( {P}_{T} - x ) + ( {P}_{T} - ( T - x ) )$$

$$CL \leq 2 PT - T$$

As shown in the above expression, the limit value C_{L} is set to a value equal to or less than a value obtained by subtracting the predetermined period T from twice the threshold P_{T}.

In FIG. 4, the receipt interval of the normal data frames F1 and F3 is the predetermined period T. However, in a case where the receipt interval of the normal data frames F1 and F3 becomes longer than the predetermined period T due to a difference between the time-stamping time and the actual receipt time or a delay due to congestion of the communication network 2, the determination value C may not reach the limit value C_{L} when receiving the data frame F3 in the setting of the limit value C_{L} described above.

Therefore, more preferably, the limit value C_{L} is set to a value equal to a value obtained by subtracting a maximum value P_{Max} of a receipt interval between two normal data frames transmitted from the ECU 20 from twice the threshold P_{T} (i.e., the limit value C_{L}=2×the threshold P_{T}−the maximum value P_{Max} of the receipt interval). Since the limit value C_{L} in this manner, the determination value reaches the limit value C_{L} every time a subsequent one of two normal data frames is received from the ECU 20 while an unauthorized data frame is inserted between the two normal data frames.

The maximum value P_{Max} of the receipt interval may be, for example, a maximum value of a receipt interval measured when data frames are transmitted at the predetermined period T by the ECU 20 actually mounted on the in-vehicle system 1. In another example, the maximum value P_{Max} may be a value of 110% or 120% of the predetermined period T at which the ECU 20 transmits the data frames.

The above-described limit value C_{L} is merely an example of a setting in a case where the difference between the receipt interval P and the threshold P_{T} is set to a predetermined value, and is not limited to this example. For example, when a numerical value associated with a magnitude of the difference between the receipt interval P and the threshold P_{T} is set to a predetermined value, the limit value C_{L} may be set to a value different from the above-described limit value.

### (c) Proximity Receipt Interval (D)

Next, a proximity receipt interval D used in each embodiment will be described. The proximity receipt interval D is a receipt interval that is a criterion for determining whether two data frames are received in proximity to each other. That is, when the receipt interval P between two data frames is equal to or less than the proximity receipt interval D, it is determined that these two data frames are data frames received in proximity to each other.

The proximity receipt interval D is set such that the determination value C immediately reaches the limit value C_{L} when two data frames are received in proximity. That is, the proximity receipt interval D is set such that the difference between the threshold P_{T} and the proximity receipt interval D is equal to or greater than the limit value C_{L}. In this case, the following mathematical expressions are established.

$$\begin{matrix}PT - D \geq {C}_{L} \\ D \leq {P}_{T} - {C}_{L}\end{matrix}$$

As shown in the above expressions, the proximity receipt interval D is set to a value equal to or less than a value obtained by subtracting the limit value C_{L} from the threshold value P_{T}.

As described above, preferably, the threshold P_{T} may be set to a value equal to the minimum value P_{Min} of the receipt interval of the normal data frames, and the limit value C_{L} is set to a value obtained by subtracting the maximum value P_{Max} Of the receipt interval of the normal data frames from twice the threshold P_{T}. When the threshold P_{T} and the limit value C_{L} are set to these values, the proximity receipt interval D may be expressed by the following expressions.

$$D = ( the minimum value {P}_{Min} of the receipt interval ) - \{ 2 \times ( the minimum value {P}_{Min} of the receipt interval ) - the maximum value {P}_{Max} of the receipt interval \}$$

$$D = the maximum value {P}_{Max} of the receipt interval - the minimum value {P}_{Min} of the receipt interval$$

That is, the proximity receipt interval D is set to a value equal to a value obtained by subtracting the minimum value P_{Min} of the receipt interval of the normal data frames from the maximum value P_{Max} of the receipt interval of the normal data frames.

### First Embodiment

Next, a method of determining an abnormal frame by the frame determiner 110 according to the first embodiment will be described.

The frame determiner 110 first determines whether the determination value C reaches the limit value C_{L} for the “first time”. As an example, the frame determiner 110 determines that the determination value C reaches the limit value C_{L} for the first time by determining that the determination value C reaches the limit value C_{L} by addition of a predetermined value to the determination value C that is less than the limit value C_{L}. In another example, the frame determiner 110 may determine that the determination value C reaches the limit value C_{L} for the first time by determining that the determination value C reaches the limit value C_{L} by addition of a predetermined value to the initial value Cₘᵢₙ of the determination value C a predetermined number of times set in advance. Alternatively, the frame determiner 110 may determine that the determination value C reaches the limit value C_{L} for the first time by determining that the determination value C reaches the limit value C_{L} by adding a predetermined value to the determination value C a predetermined number of times for the first time after a predetermined value is subtracted from the determination value C by the value updater 107. For example, as described above, the predetermined number of times may be set to two when the limit value C_{L} is set such that the determination value C reaches the limit value C_{L} at the time of receiving of a subsequent one of two normal data frames while an abnormal frame is inserted between the two normal data frames. In this case, when the predetermined value is added to the initial value twice due to insertion of the abnormal frame between two normal data frames, the frame determiner 110 determines that the determination value C reaches the limit value C_{L} for the first time.

Here, the term “first time” includes, for example, not only a case where the determination value C reaches the limit value C_{L} for the first time after activation of the device but also a case where the determination value C reaches the limit value C_{L} for the first time within a predetermined period and a case where the determination value C reaches the limit value C_{L} for the first time after a predetermined condition is satisfied.

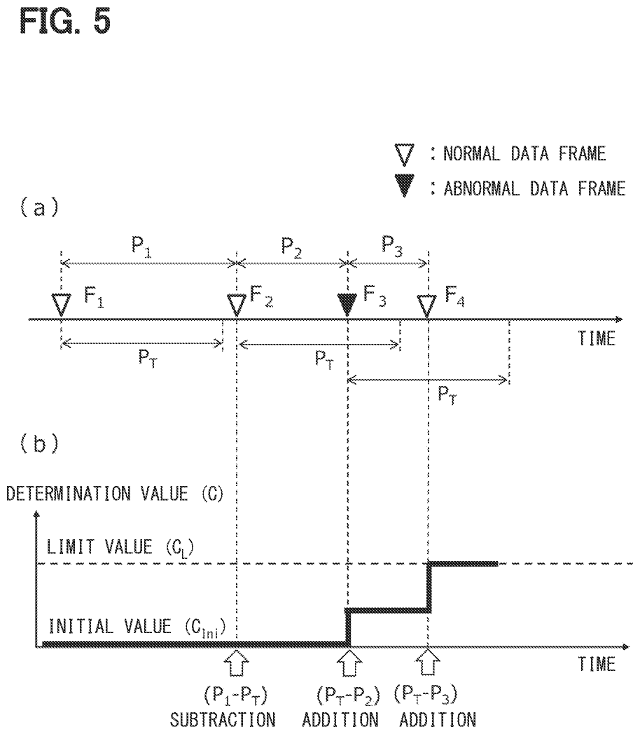

FIG. 5 is a diagram illustrating an example of a case where four data frames F1 to F4 are received. FIG. 5(a) shows time-stamping times at which time stamps are added to the data frames F1 to F4, and receipt intervals P1, P2, P3 based on the time-stamping times. FIG. 5(b) shows the determination value C that changes according to the receipt intervals P1, P2, P3 of the data frames F1 to F4. In the example of FIG. 5, among the four data frames, the data frames F1, F2, F4 are normal data frames, and the data frame F3 is an abnormal frame.

Here, in the following example, the initial value Cₘᵢₙ of the determination value C is equal to the minimum value Cₘᵢₙ of the determination value C, and the predetermined number of times is set to two.

For example, in the example illustrated in FIG. 5, since the receipt interval P1 between the data frame F1 and the data frame F2 is longer than the threshold P_{T}, the value updater 107 subtracts the difference (P1−P_{T}) between the receipt interval P1 and the threshold P_{T} from the determination value C. However, in this example, the value of the determination value C before the subtraction process is equal to the initial value Cₘᵢₙ which is the minimum value Cₘᵢₙ of the determination value C (i.e., Cₘᵢₙ=0). Thus, the determination value C after the updating is still equal to the initial value Cₘᵢₙ. Next, the receipt interval P2 between the data frame F2 and the data frame F3 and the receipt interval P3 between the data frame F3 and the data frame F4 are both shorter than the threshold P_{T}. Therefore, the value updater 107 adds the difference between the receipt interval P2 and the threshold P_{T} to the determination value C and the difference between the receipt interval P3 and the threshold P_{T} to the determination value C. As illustrated in FIG. 5(b), when the difference (P_{T}−P3) between the receipt interval P3 and the threshold P_{T} is added to the determination value C, the determination value C reaches the limit value C_{L}, and thus the abnormality determiner 109 determines that an abnormal frame is present.

Here, in FIG. 5, the value updater 107 subtracts a predetermined value from the determination value C when receiving the data frame F2, and then adds a predetermined value to the determination value C twice when receiving the data frame F3 and the data frame F4. Accordingly, the determination value C reaches the limit value C_{L}. Therefore, when the abnormality determiner 109 determines that an abnormal frame is present at the time of receiving the data frame F4, the frame determiner 110 determines that the determination value C reaches the limit value C_{L} for the first time.

In FIG. 5, the value updater 107 adds a predetermined value twice to the initial value Cₘᵢₙ of the determination value C, and thereby the determination value C reaches the limit value C_{L}. In addition, the value updater 107 adds a predetermined value to the determination value C less than the limit value C_{L}, in other words, the value updater 107 adds the determination value C obtained by adding P_{T}−P2 to the initial value Cₘᵢₙ, and thereby the determination value C reaches the limit value C_{L}. Therefore, according to these, the frame determiner 110 can determine that the determination value C reaches the limit value C_{L} for the first time.

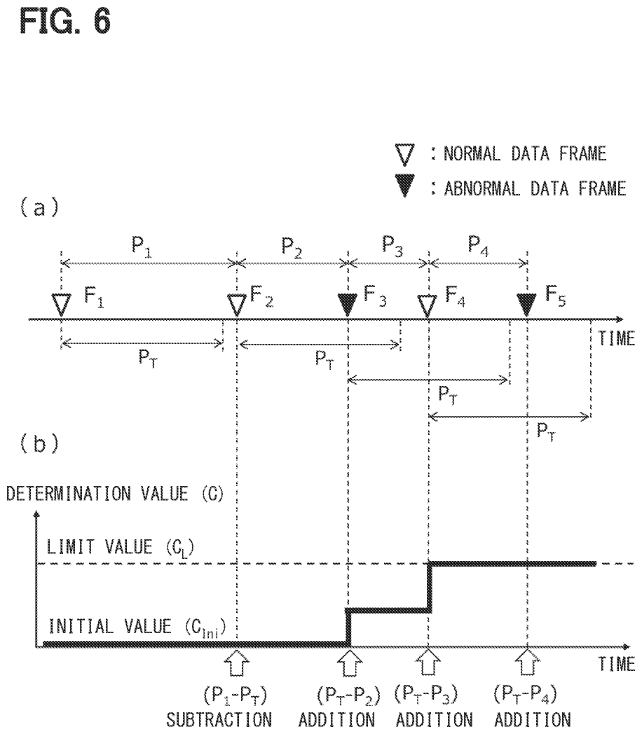

FIG. 6 illustrates a case where an abnormal frame F5 is further received after receiving the data frame F4 in FIG. 5. Since a receipt interval P4 between the data frame F4 and the data frame F5 is shorter than the threshold P_{T}, the value updater 107 adds the difference (P_{T}−P4) between the receipt interval P4 and the threshold P_{T} to the determination value C. However, since the determination value C before the updating is equal to the limit value C_{L} of the determination value C, i.e., the maximum value Cₘₐₓ, the determination value C after the updating is still equal to the limit value C_{L}. Then, since the determination value C after the updating has reached the limit value C_{L}, the abnormality determiner 109 determines that an abnormal frame is present. Here, when the abnormality determiner 109 determines that an abnormal frame is present at the time of receiving the data frame F5, the value updater 107 adds a predetermined value three times to the determination value C, and thereby the determination value C reaches the limit value C_{L}. Therefore, the frame determiner 110 does not determine that the determination value C reaches the limit value C_{L} for the first time. As described with reference to FIG. 5, the determination value C reaches the limit value C_{L} at the time of receiving the data frame F4 and the abnormality determiner 109 determines that an abnormal frame is present. Therefore, it is obvious that it is not the first time that the determination value C reaches the limit value C_{L} at the time of receiving the data frame F5.

In the example of FIG. 6, when the abnormality determiner 109 determines that an abnormal frame is present at the time of receiving the data frame F5, the value updater 107 adds a predetermined value to the determination value C that is equal to or greater than the limit value C_{L}. From this, when the determination value C reaches the limit value C_{L} at the time of receiving the data frame F5, it can be determined that it is not the first time that the determination value C reaches the limit value C_{L}.

Alternatively, the frame determiner 110 may determine that the determination value C reaches the limit value C_{L} for the first time when the determination value C reaches the limit value C_{L} by adding the predetermined value twice after subtraction of the predetermined value and the determination value obtained by the subtraction of the predetermined value is equal to the initial value Cₘᵢₙ of the determination value C. Here, the determination value after the predetermined value is added for the second time is assumed to be C, the determination value before being updated to the determination value C and after the predetermined value is added for the first time is assumed to be C1, and the determination value before being updated to the determination value C1 is assumed to be C2. The determination values C, C1 and C2 are stored in the storage 106. When the determination value C2 obtained by the subtraction of the predetermined value is not equal to the initial value Cₘᵢₙ, the determination value C includes a value added due to a recent data frame received at the time of the abnormality determiner 109 determining that an abnormal frame is present, and a value added due to an abnormal frame received before a data frame received immediately before the recent data frame. On the other hand, when the determination value C2 obtained by the subtraction of the predetermined value is equal to the initial value, the determination value C is not affected by the value added due to the abnormal frame received in the past. Therefore, when the determination value C2 obtained by the subtraction of the predetermined value is equal to the initial value Cₘᵢₙ of the determination value C, it may be determined that the determination value C reaches the limit value C_{L} for the first time.

The method of the frame determiner 110 for determining whether the determination value C reaches the limit value C_{L} for the first time is not limited to the above-described example. For example, when a predetermined period has elapsed since the abnormality determiner 109 last determined that an abnormal frame was present in the past, the frame determiner 110 may determine that the determination value C reach the limit value C_{L} for the first time.

When the frame determiner 110 determines that it is not the first time that the determination value C reaches the limit value C_{L}, the frame determiner 110 determines that at least one of a currently received data frame received at the time of determining that an abnormal frame is present and an immediately preceding data frame received immediately before receipt of the currently received data frame is the abnormal frame. In the example of FIG. 6, when the abnormality determiner 109 determines that an abnormal frame is present at the time of receiving the data frame F5, the frame determiner 110 determines that it is not the first time that the determination value C reaches the limit value C_{L}, and determines that at least one of the data frame F5 received at the time of determining that an abnormal frame is present and the data frame F4 received immediately before the data frame F5 is the abnormal frame. In other words, when a predetermined value is further added to the determination value C equal to or greater than the limit value C_{L}, the frame determiner 110 determines that at least one of the data frame F5 received at the time of determining that an abnormal frame is present and the data frame F4 received immediately before the data frame F5 is the abnormal frame.

On the other hand, when the frame determiner 110 determines that the determination value C reaches the limit value C_{L} for the first time, the frame determiner 110 further determines whether the currently received data frame received at the time of determining that an abnormal frame is present and the immediately preceding data frame received immediately before the currently received data frame are received in proximity to each other. Whether the two data frames are received in proximity to each other is determined based on whether the receipt interval between the two data frames is shorter than the proximity receipt interval D.

As described above, the proximity receipt interval D is a receipt interval as a criterion for determining whether two data frames are received in proximity, and when the receipt interval between two data frames is longer than the proximity receipt interval D, it is determined that these data frames are not received in proximity. When the receipt interval between the two data frames is equal to or less than the proximity receipt interval D, it is determined that the two data frames are received in proximity. When the receipt interval P between the two data frames is equal to or less than the proximity receipt interval D, the difference between the threshold P_{T} and the receipt interval P becomes a value larger than the limit value C_{L}, and the determination value C immediately reaches the limit value C_{L}.

When the frame determiner 110 determines that the receipt interval P between the two data frames is longer than the proximity receipt interval D, the frame determiner 110 determines that the immediately preceding data frame received immediately before the currently received data frame received at the time of determining that an abnormal frame is present is the abnormal frame. On the other hand, when the frame determiner 110 determines that the receipt interval P between the two data frames is equal to or less than the proximity receipt interval D and the two data frames are received in proximity to each other, the frame determiner 110 determines that at least one of the currently received data frame received at the time of determining that an abnormal frame is present and the immediately preceding data frame received immediately before the currently received data frame is the abnormal frame. For example, in the example of FIG. 5, the determination value C reaches the limit value C_{L} for the first time at the time of receiving the data frame F4. The receipt interval P3 between the data frame F3 and the data frame F4 is longer than the proximity receipt interval D. Therefore, the frame determiner 110 determines that the data frame F3 received immediately before the data frame F4 received at the time of determining that an abnormal frame is present is the abnormal frame.

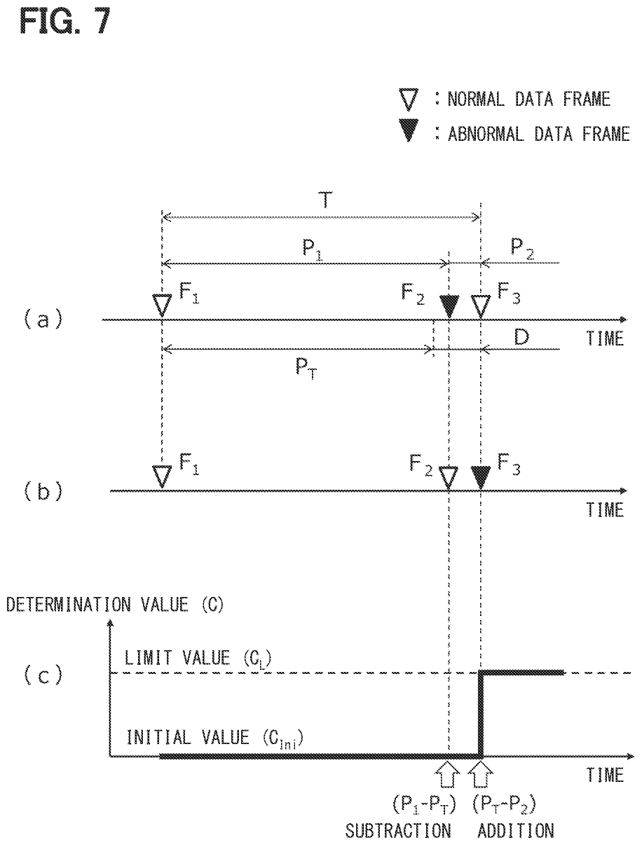

FIG. 7 is a diagram illustrating an example of a case where three data frames F1 to F3 are received. FIGS. 7(a) and 7(b) show time-stamping times at which time stamps are added to the data frames F1 to F3, and receipt intervals P1, P2 based on the time-stamping times. FIG. 7(c) shows the determination value C that changes according to the receipt intervals P1, P2 of the data frames F1 to F3. FIG. 7(a) and FIG. 7(b) each show a case where the data frame F2 and the data frame F3 are received in proximity to each other. In FIG. 7(a), the data frame F2 is an abnormal frame, whereas in FIG. 7(b), the data frame F3 is an abnormal frame.

In FIG. 7(a), as described above, since the data frame F2 and the data frame F3 are received in proximity to each other, the receipt interval P2 is shorter than the proximity receipt interval D. Here, when a receipt interval (P1+P2) between the normal data frame F1 and the data frame F3 is equal to the predetermined period T which is the transmission interval of the ECU 20, the receipt interval P1 between the normal data frame F1 and the abnormal frame F2 is longer than the threshold P_{T}. Therefore, at the time of receiving the data frame F2, the process of adding a predetermined value to the determination value C is not executed. Then, when the data frame F3 is received, a difference (P_{T}−P2) between the threshold P_{T} and the receipt interval P2 is added to the determination value C, so that the determination value C reaches the limit value C_{L}.

Similarly, in FIG. 7(b), since the data frame F2 and the data frame F3 are received in proximity to each other, the receipt interval P2 is shorter than the proximity receipt interval D. Since the receipt interval P1 between the normal data frame F1 and the normal data frame F2 is longer than the threshold P_{T}, the process of adding a predetermined value to the determination value C is not executed at the time of receiving the data frame F2. Then, when the data frame F3 is received, a difference (P_{T}−P2) between the threshold P_{T} and the receipt interval P2 is added to the determination value C, so that the determination value C reaches the limit value C_{L}.

In FIGS. 7(a) and 7(b), the receipt interval P1 between the data frame F1 and the data frame F2 and the receipt interval (P1+P2) between the data frame F1 and the data frame F3 are both longer than the threshold P_{T} and are receipt intervals of normal data frames. That is, both the receipt time of the data frame F2 and the receipt time of the data frame F3 can be the receipt time of the normal data frame received after receipt of the normal data frame F1. In addition, in both of FIGS. 7(a) and 7(b), since the determination value C changes as illustrated in FIG. 7C, it is difficult to specify which of the data frame F2 and the data frame F3 is an abnormal frame. That is, when two data frames are received in proximity to each other, it is difficult to determine which of the two data frames is an abnormal frame. Therefore, in this case, the frame determiner 110 determines that at least one of a currently received data frame received at the time of abnormality detection and an immediately preceding data frame received immediately before the currently received data frame is the abnormal frame. In the case of FIG. 7, it is determined that at least one of the data frames F2 and F3 is an abnormal frame.

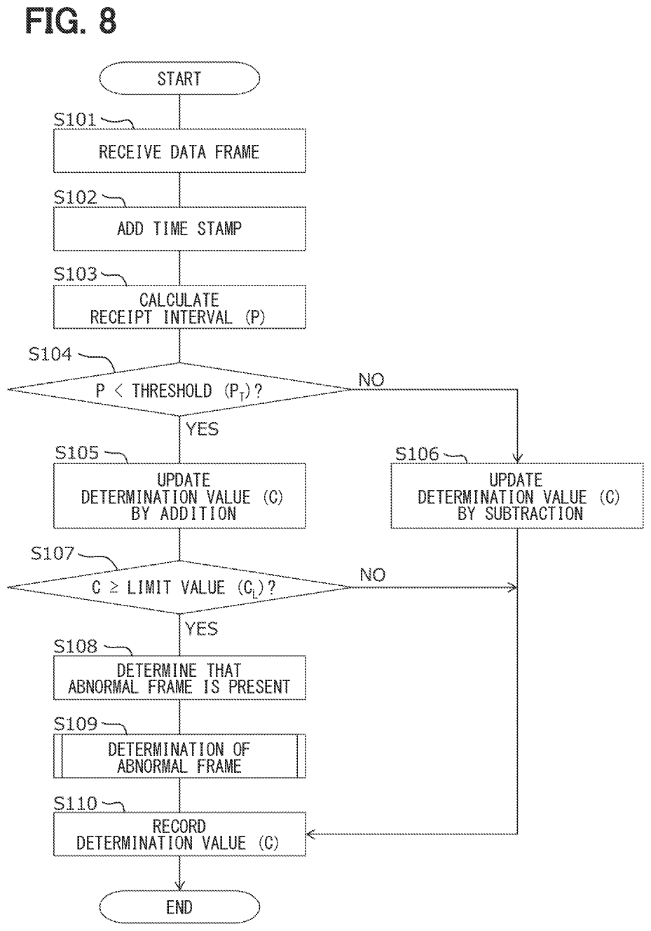

Next, the operation of the abnormal frame determination device 10 will be described with reference to FIG. 8. FIG. 8 shows not only a method of determining an abnormal frame in the abnormal frame determination device 10 but also a process of processing of the program executed by the abnormal frame determination device 10. The process is not limited to the order illustrated in FIG. 8. That is, the order may be properly changed as long as there is no restriction such as a relationship in which a result of a preceding step is used in a subsequent step. The same applies to the flowcharts of the following embodiments. The processing illustrated in FIG. 8 is repeatedly executed every time the abnormal frame determination device 10 receives a data frame.

In step S101, the receiver 101 receives a data frame estimated to have been transmitted from the ECU 20.

In step S102, the time stamper 103 adds a time stamp to the currently received data frame.

In step S103, the interval calculator 104 calculates a receipt interval P between the currently received data frame received in step S101 and an immediately preceding data frame received by the receiver 101 immediately before the currently received data frame based on the time indicated by the time stamp added in step S102.

In step S104, the value updater 107 compares the receipt interval P calculated in step S103 with the threshold P_{T} of the receipt interval P. When the receipt interval P is shorter than the threshold P_{T} (YES in step S104), the process proceeds to step S105. On the other hand, when the receipt interval P is longer than or the threshold (NO in step S104), the process proceeds to step S106. In the flowchart of FIG. 8, the process proceeds to step S106 even when the receipt interval P is equal to the threshold P_{T}. However, when the receipt interval P is equal to the threshold P_{T}, the process may proceed to step S105. Steps S105 and S106 are both a process of updating the determination value C in the value updater 107.

When the receipt interval P is shorter than the threshold P_{T} (YES in step S104), the value updater 107 adds a difference (P_{T}−P) between the receipt interval P calculated in step S103 and the threshold P_{T} to the determination value C stored in the storage 106 to update the determination value in step S105. Here, when the determination value C after the addition is equal to or greater than the maximum value Cₘₐₓ of the determination value C, the maximum value Cₘₐₓ of the determination value C is set as the determination value C in step S105.

Next, in step S107, the abnormality determiner 109 compares the determination value C updated in step S105 with the limit value C_{L}.

Here, when the determination value C has reached the limit value (YES in step S107), the abnormality determiner 109 determines in step S108 that an abnormal frame is present among received data frames.

Then, in step S109, the frame determiner 110 determines which of the received data frames is the abnormal frame. Details of processing in step S109 will be described later in detail.

When the receipt interval P is longer than the threshold P_{T} (NO in step S104), the value updater 107 updates the determination value C in step S106 by subtracting a difference (P−P_{T}) between the receipt interval P calculated in step S103 and the threshold P_{T} from the determination value C stored in the storage 106. Here, when the determination value C after the subtraction is equal to or less than the minimum value Cₘᵢₙ of the determination value C, the minimum value Cₘᵢₙ of the determination value C is set as the determination value C in step S106.

In step S110, the determination value C updated in step S105 or S106 is stored in the storage 106, and the process ends.

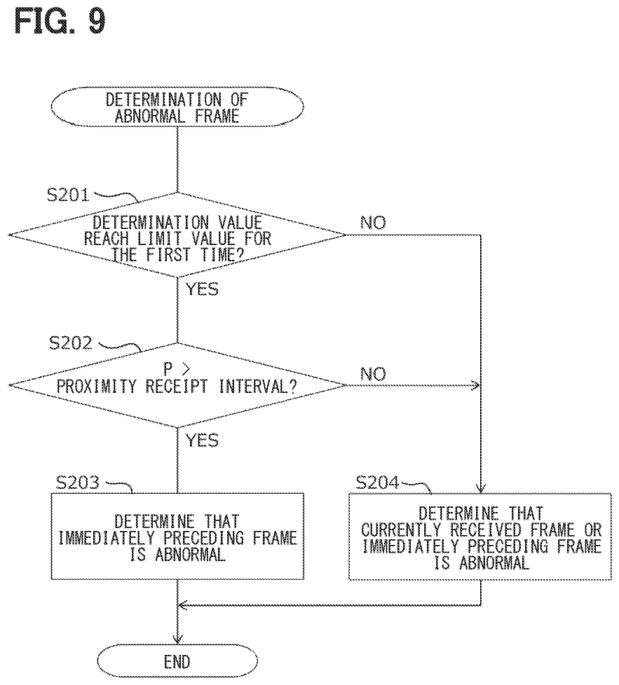

FIG. 9 is a diagram illustrating the process of step S109.

In step S201, the frame determiner 110 determines whether the determination value C reaches the limit value C_{L} for the first time. As described above, an arbitrary method may be adopted as a method of determining whether the determination value reaches the limit value for the first time.

When the frame determiner 110 determines that the determination value C reaches the limit value C_{L} for the first time (YES in step S201), the frame determiner 110 further determines in step S202 whether the receipt interval P between the currently received data frame received in step S101 and the immediately preceding data frame received immediately before the currently received data frame is shorter than the proximity receipt interval D, that is, whether the two data frames are received in proximity to each other.

When the receipt interval P is longer than the proximity receipt interval D, i.e., the currently received data frame and the immediately preceding data frame received immediately before the currently received data frame are not received in proximity to each other, the frame determiner 110 determines that the immediately preceding frame is an abnormal frame in step S203.

When it is not the first time that the determination value C reach the limit value C_{L} (NO in step S201), or when the receipt interval P is equal to or less than the proximity receipt interval D (NO in step S202), the frame determiner 110 determines in step S204 that at least one of the currently received data frame and the immediately preceding data frame received immediately before the currently received data frame is an abnormal frame.

According to the present embodiment, when a predetermined condition is satisfied, the frame determiner 110 determines that the immediately preceding data frame received immediately before the currently received data frame is an abnormal frame. Even when the predetermined condition is not satisfied, the frame determiner 110 determines that at least one of the currently received data frame and the immediately preceding data frame is an abnormal frame.

### Second Embodiment

In the above-described first embodiment, after the determination value C reaches the limit value C_{L}, the determination value C is stored in the storage 106 as the limit value C_{L} that is the maximum value Cₘₐₓ. In the second embodiment, when the determination value C reaches the limit value C_{L}, the determination value is reset to the initial value Cₘᵢₙ. Hereinafter, the configuration of the second embodiment will be described focusing on differences from the first embodiment.

The configuration of the abnormal frame determination device 10 of the present embodiment is the same as that of first embodiment, and will be described with reference to FIG. 2. Each configuration of the abnormal frame determination device 10 has the same function as that of the first embodiment. In the present embodiment, when the determination value C reaches the limit value C_{L}, the determination value C is reset to the initial value Cₘᵢₙ. Therefore, a case where the determination value C reaches the limit value C_{L} corresponds to a case where the determination value C reaches the limit value C_{L} for the first time after the determination value C is reset. Therefore, the frame determiner 110 of the present embodiment does not need to determine whether the determination value C reaches the limit value C_{L} for the first time.

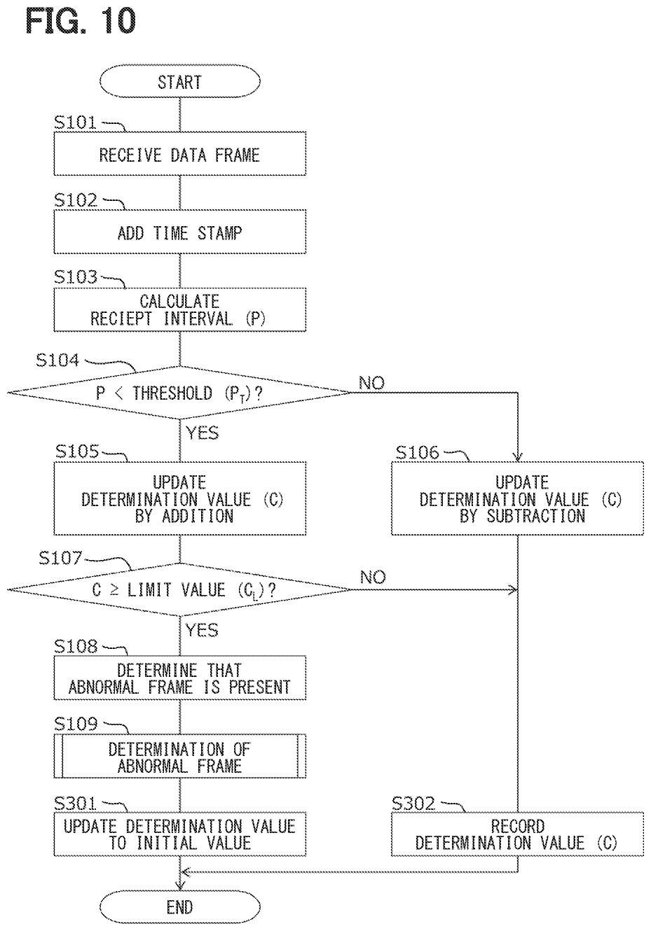

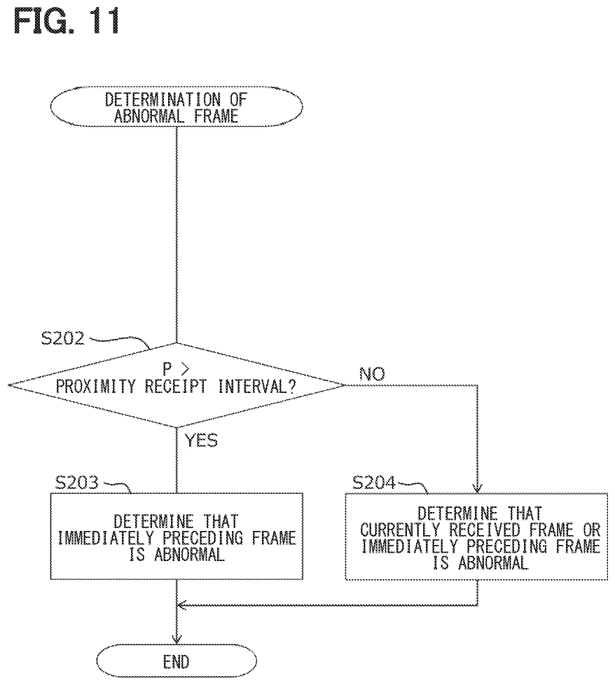

The operation of the abnormal frame determination device 10 of the present embodiment will be described with reference to FIGS. 10 and 11. Descriptions of processing common to FIG. 8 will be omitted. In FIG. 8, after the abnormal frame is determined in step S109, the determination value C updated in step S105 or S106 is stored in the storage 106 in step S110. However, in the present embodiment, as illustrated in FIG. 10, after the abnormal frame is determined in step S109, the determination value C is updated to the initial value Cₘᵢₙ in step S301, thereby resetting the determination value C. Only when the receipt interval P calculated in step S103 is longer than the threshold P_{T} (NO in step S104) or when the determination value C does not reach the limit value C_{L} (NO in step S107), the determination value C updated in step S105 or step S106 is stored in the storage 106 in step S302.

FIG. 11 is a diagram illustrating the process of step S109 in FIG. 10. Unlike FIG. 9, the process of step S201 is not executed. This is because, in the present embodiment, the case where the determination value C reaches the limit value C_{L} is always the case where the determination value C reaches the limit value C_{L} for the first time after the determination value C is reset.

According to the present embodiment, it is possible to determine that the immediately preceding data frame received immediately before the currently received data frame or at least one of the currently received data frame and the immediately preceding data frame is an abnormal frame without determining whether the determination value C reaches the limit value C_{L} for the first time.

The features of the abnormal frame determination device 10 and the like of the present disclosure have been described above.

Terms used in the description of each embodiment are examples and may be replaced with synonymous terms or terms having a synonymous function.

The block diagram used in the description of each embodiment is a diagram in which the configurations of devices and the like are classified and organized by function. The blocks representing the respective functions may be implemented by any combination of hardware or software. Since the blocks represent the functions, the block diagram may also be understood as disclosures of a method and a program for implementing the method.

An order of functional blocks that can be understood as processes, flows, and methods described in the embodiments may be changed as long as there is no restrictions such as a relation in which results of preceding steps are used in other steps.

The terms “first”, “second”, or “N” (N is an integer) used in each embodiment and the present disclosure are used to distinguish two or more configurations and methods of the same type, it does not limit the order or superiority.

In the above-described embodiments, the abnormal frame determination device is mounted on the vehicle. However, the present disclosure may be used for the abnormal frame determination device for special devices or general-purpose devices other than vehicles.

Further, examples of a form of the abnormal frame determination device of the present disclosure include the followings. The examples of the form as a component include a semiconductor element, an electronic circuit, a module, and a microcontroller. The examples of the form as a semi-finished product include an electronic control device (electronic control unit (ECU)) and a system board. The examples of the form as a finished product include a cellular phone, a smartphone, a tablet computer, a personal computer (PC), a workstation, and a server. Further, the examples of the form include a device having a communication function such as a video camera, a still camera, a car navigation system.

Functions such as an antenna and a communication interface may be added to the abnormal frame determination device.

In addition, the abnormal frame determination device of the present disclosure can be implemented by not only dedicated hardware having the configurations and functions described in each embodiment but also as a combination of a program stored in a non-transitory tangible storage medium such as a memory or a hard disk and provided to implement the present disclosure, and general-purpose hardware having a dedicated or general-purpose CPU, which can execute the program, and having a memory and the like.

The program stored in the non-transitory tangible storage medium (e.g., an external storage device such as a hard disk, a USB memory, and a CD/BD, or an internal storage device such as a RAM and a ROM) of the dedicated or general-purpose hardware may also be transmitted to the dedicated or general-purpose hardware via the storage medium or via a communication line from a server without using the storage medium. As a result, it is possible to provide a latest function by updating the program.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. An abnormal frame determination device configured to be connected to an electronic control unit configured to transmit data frames at a predetermined period, the abnormal frame determination device comprising a processor configured to:
receive a first data frame estimated to have been transmitted from the electronic control unit;
calculate a receipt interval between the first data frame and a second data frame, the second data frame being a data frame received immediately before receiving of the first data frame;
add a predetermined value to a determination value stored in a storage when the receipt interval is shorter than a threshold; and
determine that the second data frame is an abnormal frame when the determination value reaches a limit value and the receipt interval is longer than a proximity receipt interval that is a criterion for determining whether the first data frame and the second data frame are received in proximity to each other.

2. The abnormal frame determination device according to claim 1, wherein
the processor is configured to determine that at least one of the first data frame and the second data frame is the abnormal frame when the receipt interval is equal to or shorter than the proximity receipt interval.

3. The abnormal frame determination device according to claim 1, wherein
the processor is configured to determine that the second data frame is the abnormal frame when the determination value reaches the limit value for first time and the receipt interval is longer than the proximity receipt interval.

4. The abnormal frame determination device according to claim 3, wherein
the processor is configured to determine that the determination value reaches the limit value for first time when the determination value reaches the limit value by adding the predetermined value to an initial value of the determination value a predetermined number of times.

5. The abnormal frame determination device according to claim 3, wherein
the processor is configured to subtract the predetermined value from the determination value when the receipt interval is longer than the threshold, and
the processor is configured to determine that the determination value reaches the limit value for first time when the determination value reaches the limit value by adding the predetermined value to the determination value a predetermined number of times after the predetermined value is subtracted from the determination value.

6. The abnormal frame determination device according to claim 1, wherein
the processor is configured to determine that the second data frame is the abnormal frame when the determination value reaches the limit value by adding the predetermined value to the determination value less than the limit value and the receipt interval is longer than the proximity receipt interval.

7. The abnormal frame determination device according to claim 1, wherein
the processor is configured to determine that at least one of the first data frame and the second data frame is the abnormal frame when the predetermined value is further added to the determination value equal to or greater than the limit value.

8. The abnormal frame determination device according to claim 1, wherein
the threshold is equal to or less than the predetermined period.

9. The abnormal frame determination device according to claim 8, wherein
the threshold is equal to a minimum value of a receipt interval of data frames transmitted from the electronic control unit.

10. The abnormal frame determination device according to claim 1, wherein
the predetermined value is a difference between the receipt interval and the threshold, and
the limit value is equal to or less than a value obtained by subtracting the predetermined period from twice the threshold.

11. The abnormal frame determination device according to claim 10, wherein
the limit value is equal to a value obtained by subtracting a maximum value of a receipt interval of the data frames transmitted from the electronic control unit from twice the threshold.

12. The abnormal frame determination device according to claim 10, wherein
the processor is configured to subtract the difference from the determination value when the receipt interval is longer than the threshold, and
the processor is configured to determine that the second data frame is the abnormal frame when the determination value reaches the limit value by adding the difference twice after subtraction of the difference from the determination value and the receipt interval is longer than the proximity receipt interval.

13. The abnormal frame determination device according to claim 1, wherein
the predetermined value is a difference between the receipt interval and the threshold, and
the proximity receipt interval is equal to or less than a value obtained by subtracting the limit value from the threshold.

14. The abnormal frame determination device according to claim 13, wherein
the proximity receipt interval is equal to a value obtained by subtracting a minimum value of a receipt interval of the data frames transmitted from the electronic control unit from a maximum value of the receipt interval of the data frames transmitted from the electronic control unit.

15. The abnormal frame determination device according to claim 1, wherein
the predetermined value is a value based on a difference between the receipt interval and the threshold.

16. The abnormal frame determination device according to claim 1, wherein
a maximum value of the determination value is equal to the limit value.

17. An abnormal frame determination method executed by an abnormal frame determination device connected to an electronic control unit configured to transmit data frames at a predetermined period, the method comprising:
receiving a first data frame estimated to have been transmitted from the electronic control unit;
calculating a receipt interval between the first data frame and a second data frame, the second data frame being a data frame received immediately before the receiving of the first data frame;
adding a predetermined value to a determination value stored in a storage based on determining that the receipt interval is shorter than a threshold; and
determining that the second data frame is an abnormal frame based on determining that the determination value reaches a limit value and the receipt interval is longer than a proximity receipt interval that is a criterion for determining whether the first data frame and the second data frame are received in proximity to each other.

18. A non-transitory computer readable medium storing an abnormal frame determination program comprising instructions executable by an abnormal frame determination device connected to an electronic control unit configured to transmit data frames at a predetermined period, the instructions being configured to, when the program is executed by the abnormal frame determination device, cause the abnormal frame determination device to carry out:
receiving a first data frame estimated to have been transmitted from the electronic control unit;
calculating a receipt interval between the first data frame and a second data frame, the second data frame being a data frame received immediately before the receiving of the first data frame;
adding a predetermined value to a determination value stored in a storage based on determining that the receipt interval is shorter than a threshold; and
determining that the second data frame is an abnormal frame based on determining that the determination value reaches a limit value and the receipt interval is longer than a proximity receipt interval that is a criterion for determining whether the first data frame and the second data frame are received in proximity to each other.
